(19) United States
(12) Patent Application Publication
(10) Pub. No.: US 2007/0174202 A1
(43) Pub. Date: Jul. 26, 2007

(54) System and method for enabling software programs which need to be enabled

(76) Inventors: Walter Dorsch, Hetzles (DE); Ulrich Kaus, Munchen (DE); Jurgen Olomski, Herzogenaurach (DE); Lothar Trapp, Feucht (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/563,476

(22) PCT Filed: May 28, 2004
(86) PCT No.: PCT/EP04/05827

§ 371 Date: May 25, 2006

(30) Foreign Application Priority Data
Jul. 3, 2003 (DE) 103 30 191.7

(51) Int. Cl. G06Q 99/00

(52) U.S. Cl. 705/59

(57) ABSTRACT

The invention relates to a system for the execution of at least one release license software program which is used to control and/or regulate a tool machine, and/or a production machine and/or a manual automatic machine, wherein the release of the release license software program can be obtained by means of a license key. A license key handler is provided for the release thereof. The invention also relates to a corresponding method. If the system comprises various release license software programs the handling of the release and/or licensing can be correspondingly expensive and complicated. A license key handler manager enables said process to be simplified. Said license key handler manager can be technically connected to at least one and/or two or several license key handlers.

### CROSS REFERENCE TO RELATED APPLICATIONS

This application claims priority to the German application No. 10330191.7, filed Jul. 3, 2003 and to the International Application No. PCT/EP2004/005827, filed May 28, 2004 which are incorporated by reference herein in their entirety.

### FIELD OF INVENTION

The invention relates to a system and a method for enabling software programs which need to be enabled.

### BACKGROUND OF INVENTION

Methods for enabling software programs which need to be enabled, that is to say in particular which can be instantiated, are generally known. One such system relates to at least one or more automation components as are known, for example, from the field of open-loop or closed-loop control, in particular of machine tools, production machines, automatic handling machines and/or other automatic machines or systems for automation, in particular of processes. An automation component is, for example, a programmable logic controller PLC, a converter, a personal computer, a movement controller or the like. Software programs such as these, in particular for open-loop and closed-loop control of at least one automation object, must be protected against unauthorized use, for example by software protection. The software protection is deactivated, for example, by entering a license key as a unique identifier to the system for legal use of the respective software program which needs to be enabled. The software program is or can be activated in this way. Until the software protection has been deactivated, the software program cannot be used, or cannot be used completely on the respective appliance which is, in particular, an automation component. The deactivation of the software protection thus corresponds to licensing of the respective software program. The license key is handled in the software by a license key handler. A license key handler such as this has, for example, specific algorithms for identification of the license key. Furthermore, the license key handler has a control interface to a user.

Another software protection method is, for example, the use of a dongle as a copy protection plug, which can be connected to an appliance, for example to a serial or parallel interface of a CNC controller. This links the software protection to hardware and, inter alia, this involves logistic effort. Since the number of parallel, serial or other interfaces for an automation system and/or an automation component, such as a programmable logic controller—PLC—or a converter or a movement controller, is limited, the number of dongles which can be used is also limited, and thus the number of software items which need to be enabled that can be used. This is particularly disadvantageous when an OEM—Original Equipment Manufacturer—is also intended to have the capability to create software which needs to be enabled.

A further possibility for software protection is, for example, the use of floppy disks as data storage media, as is described, for example, in EP 0 745 925 A2 or EP 0 610 623 A1.

It is known from WO 00/75760 A1 for a license key to be linked by the manufacturer of the software or of the hardware to specific destination hardware, in which software which needs to be enabled is generated specifically for hardware which has an identifier.

### SUMMARY OF INVENTION

If different software problems can run on a machine tool, a production machine, an automatic handler machine or a system in particular an automation system for general or specific automation tasks, which has at least one automation component, different software programs can run within a group of such machines or automatic machines or automation systems and, in particular, use different protection mechanisms for protection of the software, then this results in disadvantages. The appropriate software protection must be set up manually and individually for each item of software that needs to be enabled. If these are different software protection mechanisms, then different procedures are required for activation or for enabling of the software. This enabling of licensed software and/or software which needs to be enabled is highly labor-intensive, particularly for a large number of licensed software programs. This is due in particular to the fact that the licensing steps frequently differ for each software program. A user who has successfully licensed a first software program has to keep the respective license key available for licensing of a further software program and has to determine which steps must be carried out for licensing and must then carry out these steps individually in order to license the software program with the associated license key, referred to for short as a key. This procedure is complicated, time-consuming and susceptible to errors, particularly for unfamiliar users. In this context, a distinction must be drawn between legal licensing and the checking of the license key. By way of example, certificates, for example, exist for verification of a license and are advantageously proof against corruption. The license key is an electronic or data representation of the legal license for a licensed software item. The process of licensing the software by means of the license key comprises a check of the electronic or data representation of the legal license for use of a licensed software item, that is to say of software which needs to be enabled by means of a software key. The procedure of checking the license key has, for example, at least one of the following effects: the software which needs to be enabled cannot run, the software which needs to be enabled can run to a restricted extent, the software which needs to be enabled can run, generation of a message to an observation appliance in order to indicate the licensing status of software which needs to be enabled.

Software is being increasingly marketed separately from the hardware in automation and drive systems. The protection of software is ensured individually by means of SW license protection. The wide range of these components in automation and drive systems is a problem.

In the case of software licenses, that is to say in the case of software that needs to be enabled, for example of:
Software in electrical drive components,
Software in an embedded runtime controller, such as machine tool controllers or a programmable logic controller, or
Software for a personal computer as
Means for control and/or for observation
Means for higher-level data acquisition for an automation task or as
Means for management control of an automation system
Software for a programmable logic controller (PLC)
Software for a machine tool controller
etc.
a user has to handle software licenses using widely differing methods and tools. As software licenses and software programs which need to be enabled are increasingly being used in automation and drive systems, and as the complexity of such installations increases, this approach is no longer feasible for a user.

It is therefore an object of the invention to specify a system and a method which are suitable for licensing of at least one software program, in particular for joint licensing of a plurality of software programs, and which overcome at least some of the disadvantages and problems described above.

According to the invention, this object is achieved by the claims.

In the case of a system for running a software program which needs to be enabled for open-loop or closed-loop control by means of at least one automation component, the software program which needs to be enabled can be enabled via a license key, with a license key handler being provided for enabling, and in which case a license key handler manager can be connected for data purposes to at least one or to two or more license key handlers.

This makes it possible to provide, in particular, a standard license management method for different automation and drive components. The automation component can be used, for example, for open-loop or closed-loop control of a machine tool, of a production machine, of an automatic handling machine, of a chemical process installation or of an electric motor, with these all being automation objects.

The expression enabling of the software program which needs to be enabled means at least the checking of the electronic or data representation of the license in the form of the license key. The check can then result in one of the already described consequences, for example the capability to run a software program that needs to be enabled, either with or without restrictions.

The license key handler is intended to handle the license key. For example, the license key handler, which is in the form of software, has an algorithm for identification of a license key.

The license key handler can also be designed in such a way that it is used for the

licensing, in particular the enabling of one or more software programs which need to be enabled. The license key handler manager is connected for data purposes to the license key handler, that is to say two software programs are provided for interchanging data. The data link is used in particular to identify the license key handler and to transmit the license key and/or the enabling information for the software. The license key handler manager can be designed in such a way that it is active both all the time or else only at times. Activation at times is advantageous, for example, when starting up an automation component or on the initial installation of at least one software program, since system resources are not loaded at other times.

A user of software (a software program) which needs to be enabled is now able to use the license key handler manager to pass on data, in particular license keys, to the license key handler. The license key handler manager can be designed in such a way that it offers the user a largely standardized operator interface irrespective of the nature of the license key handler. The user therefore does not need to select different control concepts for different license key handlers. The system according to the invention means that it is now possible to manage software programs which need to be enabled and to each of which a license key handler can be assigned, by means of a software program, the license key handler manager. In consequence, this now means that there is only one interface for a user for license enabling for software programs, thus allowing licenses to be enabled more easily and more quickly, that is to say more cost-effectively.

In one advantageous refinement of the system, there are at least two license key handlers of different types. The types of license key handlers differ in the different types of the license keys. A specific key algorithm characterizes, for example, one type. The inclusion of a data item which cannot be erased and is stored in the hardware of the automation component in a key can also form a new type of license key. The se are just a few examples of a large number of possible types.

In a further advantageous refinement of the system, the license key handler manager is provided in order to identify at least two license key handlers, and/or in order to identify a license requirement.

If license key handlers of different types can be handled using the license key handler manager, that is to say using different license key methods, this represents a major simplification for the user. In one advantageous refinement of the license key handler manager, this license key handler manager identifies the types of license key handlers which are connected to it for data purposes. If, by way of example, a type is not yet known to the license key handler manager, then the license key handler manager can be upgraded by means of a software upgrade module which can be played to it in order that it can also identify a new type, and can manage it. This option is particularly useful for OEMs since they can produce their own software programs that can be licensed. It is also advantageous when using software that can be licensed for different manufacturers or when a manufacturer has changed the type of software protection for subsequent software. In a further advantageous refinement of the license key handler manager, the license key handler manager identifies the number and the type of license keys required for the software programs which need to be enabled and are intended to be used in the system, that is to say for example in an automation system or in a machine tool controller.

In one advantageous refinement of the system, the system is a distributed system and has at least two automation components which are networked to one another for data purposes, in which case the software program which needs to be enabled can run on one of the automation components and the license key handler manager can run on this and on a further automation component and is connected for data purposes to the license key handler of at least one further automation component.

The license key handler manager can thus be operated in a system on the same hardware platform or else on a different hardware platform to that of the license key handler. This improves the flexibility.

The flexibility can also be improved by means of a floating license. In this case, by way of example, the license key handler manager assigns the license key once to the first license key handler and on another occasion to the other license key handler.

The license key handler can also be designed in such a way that it looks for software that needs to be enabled and needs to be checked not only on the automation component on which the license key handler is running but also on at least one automation component which is connected for data purposes to this automation component and on which the software which needs to be enabled can run and/or is running there.

In a further advantageous refinement of the system, the license key handler manager and the license key handler are integrated in one another in a software program. A system such as this is in consequence characterized by an upgraded license key handler which has the capability to handle different types of license keys, that is to say to carry out a check of the license keys.

In one advantageous refinement, the system according to the invention has at least one automation component or an automation component in which the automation component has runtime software. Even in the case of runtime software, licensing is important.

Another object of the invention is achieved by a method for enabling the running of at least one software program which needs to be enabled. In the case of the method for enabling the running of at least one software program which needs to be enabled and can be enabled via a license key, a license key handler manager identifies at least one of optionally at least two license key handlers which are connected to it.

The license key handler manager can thus form an interface or a type of node between a plurality of license key handlers. This interface function is assigned in particular by the license key handler manager offering an operator interface which assists the control of different license key handlers of a different type.

By way of example, the following steps are carried out in order to enable the running of a software program which needs to be enabled:
a) the license key handler manager transfers the license key to a license key memory of an identified license key handler and the license key handler receives the license key from the license key memory, or
b) the license key handler manager transfers the license key to a license key server, which passes on the license key for storage to the license key memory or supplies the license key to the license key handler, or
c) the license key handler manager transfers the license key to the license key handler, with the license key handler storing the license key in the license key memory

and in which case the running of the software program is enabled by a check or inspection of the license key in the license key handler by the software program which needs to be enabled.

There is no absolute requirement for a close time link with the transfer of the license key to the license key handler in order to enable the running of the software. By way of example, the license key can be transferred within a setting-up measure for an automation component in which case, in contrast, enabling it to run is carried out, for example, at the running time of the automation component and/or of the software which is running on it.

This results in the advantages which have already been described above. The license key may be either in the form of data information or else in the form of an autonomous software program.

The license key server is a means for the provision of information and/or data which can be checked by the server, for example by a license handler.

In one advantageous refinement of the method, the license key is used to enable a software program which needs to be enabled and is running in an embedded runtime system in an industrial automation system or a drive system which, in particular, has at least one automation component.

In a further advantageous refinement, the software programs which need to be enabled require license keys of a different type, in which case the license key handler manager transfers the license key of one type to a license key handler of this same type. In order to enable the software program which needs to be enabled, this requires enabling, that is to say checking information from the license key handler.

A license key handler is advantageously associated with a license key memory, on the basis of which the license key handler manager transfers the license key, in particular directly, to the license key memory.

In a further refinement of the method, a license key handler is associated with a license key memory, in which case the license key handler stores the license key in the license key memory and/or reads the license key from the license key memory.

A license key handler manager is advantageously associated with a plurality of license key handlers of a different type which handle license keys of a different type, and the type of license key handler is identified by the license key handler manager.

If the license key handler manager does not know a license key type, then the license key handler manager has modules for managing a license key handler of a new type added to it. License keys of the same type are, for example, different license keys which have been produced, however, by means of the same algorithm.

The invention also relates to an automation system for carrying out the method as described above. In this case, the following versions should be emphasized:
Software which requires a license key asks the license key handler whether and in what conditions it can be operated. Depending on the license situation, which is represented by the license key, the license key handler can allow or refuse the application, for example the right for operation, on a restricted or unrestricted basis.
License keys can be introduced via the license key handler manager and the license key handler into the license key memory system components.
At the running time of the automation system, a license key handler manager can ask a license key server for a license key, when required.
The license key handlers make the license requirement available to the license key handler manager.
The license key handlers notify the license key handler manager of the license key on request as required for the system component.
Download of the license key from the web license interface of the license provider. License keys can be downloaded from the Internet via a web license interface with the aid of the license key handler manager.
Download the determined license key requirement. With the aid of the license key handler manager, the license key requirement determination and the license key for the download can be downloaded automatically from the Internet for the determined license key requirement.
License keys can also be ordered from the license key handler manager with the aid of the license key handler manager and an order and delivery handling system which is integrated in the web license interface.
The determined requirement can be ordered automatically with the aid of the license key handler manager, the license key requirement determination and the license key order.
The communication to specific license key handlers from the license key handler manager can be provided by means of plugins, which are specific for these license key handlers, in the license key handler manager. The se plugins can be added to the license key handler manager retrospectively.
When an automation component is being configured, engineered or programmed from an engineering system (runtime manager, for example, S7 manager . . . ), the necessary license management tasks, such as loading of license keys in these components, can be stimulated immediately via the license key handler manager by means of this configuration information.
If a license key handler manager in a networked automation and drive system cannot communicate directly with a license key handler of an automation or drive component, then intermediate automation and drive components can pass on this necessary communication.

### BRIEF DESCRIPTION OF THE DRAWINGS

The invention will be described in the following text by way of example with reference to the exemplary embodiments which are illustrated in the figures, in which:

FIG. 1 shows a first system which has a license key handler manager,

FIG. 2 shows a second system which has a license key handler manager,

FIG. 3 shows a third system which has a license key handler manager, and

FIG. 4 shows an illustration of a method for enabling the running of a software program which needs to be enabled.

### DETAILED DESCRIPTION OF INVENTION

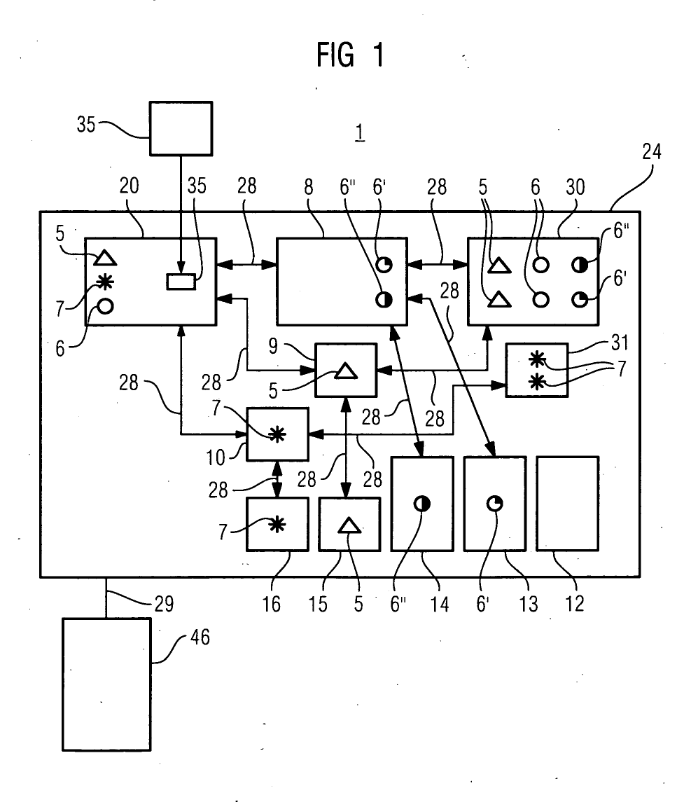

The illustration in FIG. 1 shows a system 1, in particular an automation system or an automation component 24. In addition to hardware which is not expressly illustrated in FIG. 1, the system also has software. The system 1 in this case has not only a free software program 12, which does not require a license key to run it, but also software programs 13, 14, 15 and 16 which need to be enabled. The software programs 13, 14, 15 and 16 which need to be enabled require a license key 5, 6′, 6″ and 7 to enable them, in which case the license keys are not located in the software program, although the figurative illustration there expresses the fact that a license key is associated with a software item. The license keys are of a different type, with the type being expressed by the graphical representation of a circle, triangle or star. Software keys 6 of the same type in particular also have different license keys 6′ and 6″, with the capability to distinguish between the license keys in the case of the type 6 which is represented by a circle with half of its area shaded in and by a circle with a quarter of its area being shaded in, respectively. The software programs 13, 14, 15 and 16 which need to be enabled are enabled by means of license key handlers 8, 9 and 10. The license key handler 8 handles the license keys 6′ and 6″. The license key handler 9 handles the license key 5, which is identified by a triangle, and the license key handler 10 handles the license key 7, which is identified by a star. The license key handlers 8, 9 and 10 are software programs which have a data link 28 to the software programs 13, 14, 15 and 16 which need to be enabled. The data link 28 is an internal data link, expressing the data interchange between the software elements comprising the license key handlers 8, 9 and 10 as well as the software programs 13, 14, 15 and 16. The license key handlers 8, 9 and 10 are each provided for one type as the license key 5, 6′, 6″, 7. The license key handlers 8, 9 and 10 have a data link 28 with a license key memory 30, 31. The license key memories 30, 31 can be designed such that one license key memory 31 stores, for example, only one type of license key 7. Another embodiment of the license key memory 30 allows the storage of different types of license keys 5, 6.

If the license key handler manager 20 has no information for management of one type of license key, then this information relating to the missing type can be played to it by means of a software upgrade module 35.

The license key handlers 8, 9 and 10 have a data link 28, which is indicated by a double-headed arrow, to a license key handler manager. The license key handler manager 20 assigns license keys 5, 6, 7 to the license key handlers 8, 9 and 10. The license key handlers 8, 9 and 10 are able to store these license keys 5, 6, 7 in license key memories 30, 31.

In one advantageous refinement, the license key handler manager 20 identifies a specific type of license key handler 8, 9, 10 and the type of the license key 5, 6, 7 which is handled by that license key handler 8, 9, 10. The license key handler 8, 9, 10 is used t o enable the software programs 13, 14, 15 and 16. The license keys 5, 6, 7 can be played to the license key handler manager 20. This process, which is not illustrated in FIG. 1, is carried out for example by means of a data storage medium such as a memory card, a communication link via an Internet, an Intranet or an Ethernet or the like. An IBN tool 46 can be connected to the automation component 24 by means of a data link 29 (for example a cable or a radio link). The IBN tool is, for example, setting-up software.

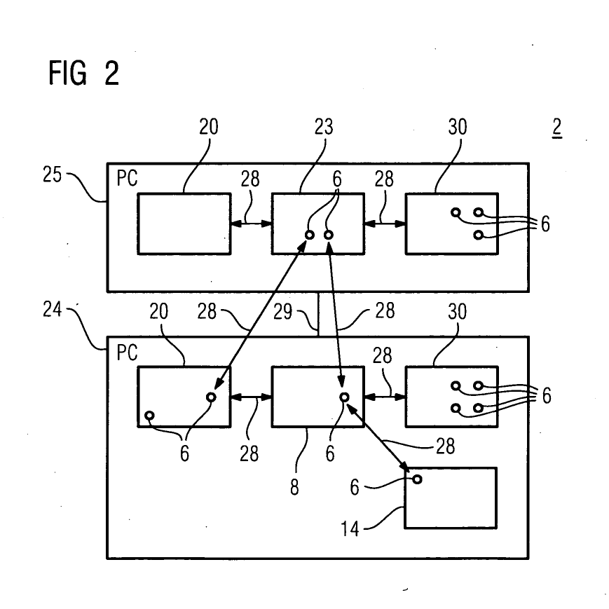

The illustration in FIG. 2 shows a system 2 which has an automation component 24 and an automation component 25. The automation component 24 is, for example, a PC on which open-loop or closed-loop control and/or movement software can run. The automation component 24 as illustrated is based on the system 1 illustrated in FIG. 1. In contrast to FIG. 1, the automation component 24 has only one license key 6 and one software program 14 that needs to be enabled, in order to simplify the illustration. The software that needs to be enabled is, for example, also a runtime software item. The license key handler manager can be called up, for example, via an engineering system which is not illustrated in FIG. 2. The design or the structure of an automation system which may have at least software as well as hardware can advantageously be generated or is known in the engineering system. This information can be used to determine license keys which may possibly be required, so that the license key handler manager can advantageously be operated via the engineering system. By way of example, the engineering system can be integrated in a PC.

The automation component 25 is also, for example, in the form of a personal computer PC. The automation component 25 has a license key handler manager 20 which has a data link 28 to a license key server 23. The license key server is used to manage license keys which, for example, are also transmitted to it by a license key manager 20 for a further automation component 24 or by a license key handler 8, or are supplied by this with license keys 6. The license key server 23 is designed in such a way that it stores license keys 6 in a license key memory 30 via a data link 28. The license key memory 30 may also be one of a plurality of components of the license key server 23. The data link 28 between the automation components 24 and 25 is provided, for example, by means of a data link 29. The data link 29 may, for example, be formed by a cable connection, a radio link or an infrared link.

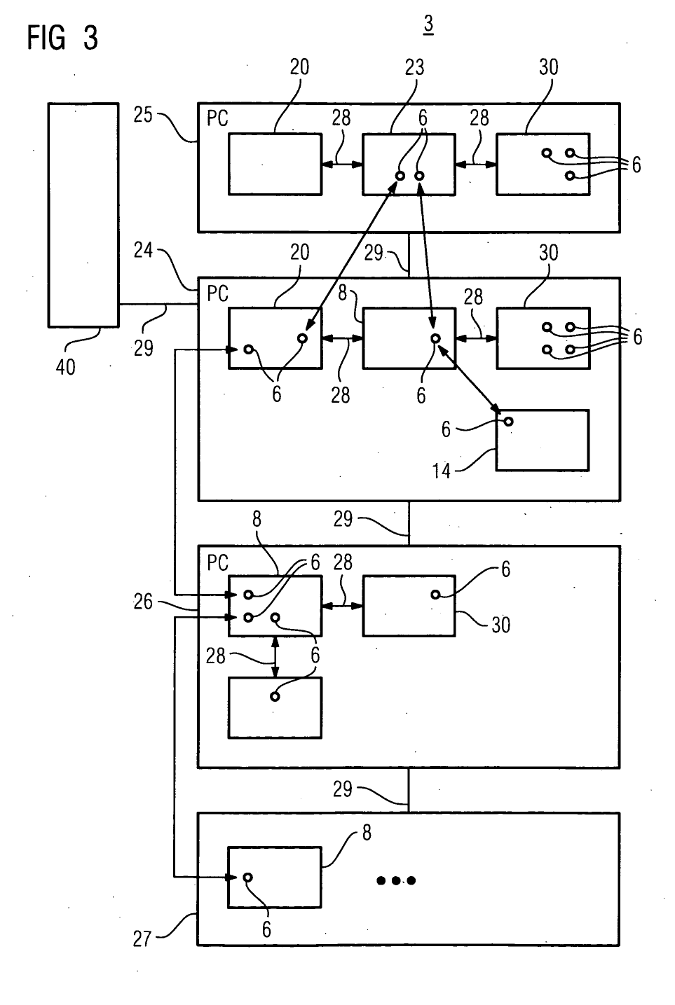

The illustration in FIG. 3 shows an extension to FIG. 2, with the system 3 as shown in FIG. 3 having further additional automation components 26 and 27 which are networked with one another by means of data links 29. By way of example, the automation component 26 is an embedded runtime system. This embedded runtime system has runtime software which needs to be enabled. The enabling process can be carried out by means of a license key handler 8 and a license key memory 30. The license key memory 30 in the automation component 26 has only one license key 6. The license key memory 8 may, for example, also be enabled in the form of a memory space, which is integrated in the license key handler, for one or more license keys, although this is not illustrated in FIG. 3.

The license key handler 8 is connected to the license key handler manager 10 for the automation component 24 by means of the data link 28. By way of example, a further license key handler 8 for an automation component 27 can also be addressed via the license key handler 8 for the automation component 26.

In one advantageous refinement, the automation component 24 is connected to a data network 40. The data network is, for example, an Internet, an Intranet, a local area network (LAN), . . . . In this way license keys, for example, can be transmitted to the license key handler manager 20. If the license key handler manager 20 does not know the type of license key, then the license key handler manager 20 can also be upgraded in this way via the data network by means of at least one module for management of a license key handler of the new type.

The system 3 is, for example, an automation system or a drive system. License keys 5, 6, 7 are represented electronically in this conventional type of license management for an automation system or drive system such as this. The license key handler manager 20 has interfaces to the license key handlers 8, which may be in different versions. For PC systems, the license key handler may be in the form of a standard version for all the PCs. For different embedded runtime systems, such as PLCs, machine tool controllers or drives, these may in each case be specifically designed depending on the requirements. There may also be different versions for the communication from the license key handler manager 20 to the license key handlers 8. Between PC components, this can be based on standard PC communication techniques, while specific communication techniques can be used for embedded runtime systems.

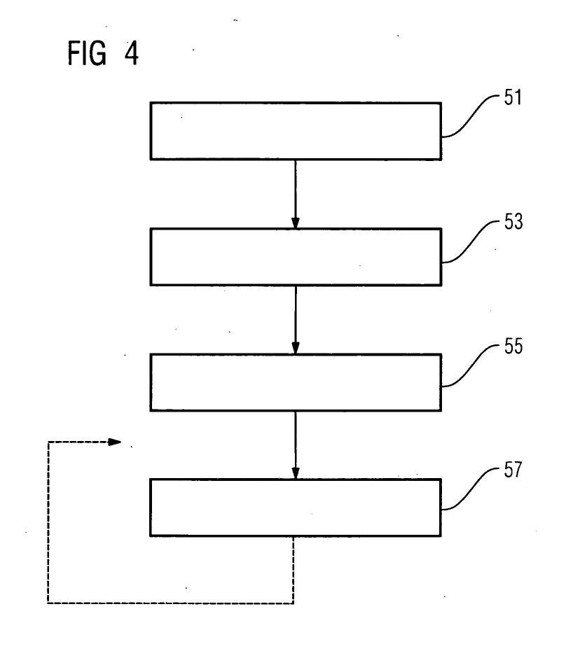

By way of example, the illustration in FIG. 4 shows method steps for enabling the running of a software program which needs to be enabled. First of all, the license key handlers are identified 51 by the license key handler manager. A license key is then transferred 53 by the license key handler manager to the license key handler. The license key handler stores the license key in a license key memory 55. The license key manager then enables 57 running. Possible repetitions of one or more method steps are symbolized by means of a feedback arrow 59, represented by a dashed line.

1.-16. (canceled)

17. A system for executing at least one software program which needs to be enabled by a license key, the software program configured for open-loop or closed-loop control when executed by least one automation component, the system comprising:
at least one license key handler for receiving a license key; and
a license key handler manager configured to be connected to and exchange data with each license key handler.

18. The system as claimed in claim 17, wherein the system comprises at least first and second license key handlers, and the license key handler manager is configured to be connected to the at least first and second license key handlers.

19. The system as claimed in claim 18, wherein the first and second license key handlers are of different types.

20. The system as claimed in claim 18, wherein the license key handler manager is configured to identify the at least first and second license key handlers.

21. The system as claimed in claim 18, wherein the license key handler manager is configured to identify a license requirement related to the software program.

22. The system as claimed in claim 17, wherein
the system is a distributed system having at least first and second automation components connected by a data link,
the license key handler is configured to be executed on the first or second automation component,
the software program is configured to be executed on the first automation components, and
the license key handler manager:
is configured to be executed on the first or second automation component, and
has a data connection to the license key handler.

23. The system as claimed in claim 17, wherein the license key handler manager and the license key handler form one integrated software program.

24. The system as claimed in claim 17, wherein the system is an automation component having runtime software.

25. A method for enabling the execution of at least one software program which needs to be enabled by via a license key, the method comprising:
providing at least first and second license key handlers of different types for receiving a license key;
connecting the first and second license handlers to a license key handler manager; and
identifying at least the first or the second license key handler by the license key handler manager.

26. The method as claimed in claim 25, further comprising:
transferring the license key to a license key memory of the identified first or second license key handler by the license key handler manager; and
retrieving the license key from the license key memory by the license key handler, wherein the execution of the software program is enabled by a check of the license key at the identified first or second license key handler using the software program.

27. The method as claimed in claim 25, further comprising:
transferring the license key to a license key server license key handler manager; and
transmitting the license key to the identified first or second license key handler by the license key server, wherein the execution of the software program is enabled by a check of the license key at the identified first or second license key handler using the software program.

28. The method as claimed in claim 27, wherein the license key is stored in and retrieved from a license key memory of the identified first or second license key handler.

29. The method as claimed in claim 25, further comprising:
transferring the license key to the license key handler by the license key handler manager; and
storing the license key in a license key memory of the identified first or second key handler, wherein the execution of the software program is enabled by a check of the license key at the identified first or second license key handler using the software program.

30. The method as claimed in claim 25, wherein the software program is executed in an embedded runtime system of an industrial automation or drive system having at least one automation component.

31. The method as claimed in claim 25, wherein at least two software programs need to be enabled by at least first and second license keys of different types, further comprising transferring the first license key to the first license key handler, wherein the first license key and the first license key handler are of the same type.

32. The method as claimed in claim 25, wherein the license key handler manager is executed on a personal computer.

33. The method as claimed in claim 25, wherein the first or second license key handler has a license key memory, and the license key handler manager transfers the license key to the license key memory.

34. The method as claimed in claim 25, wherein the first or second license handler has a license key memory, and the license key handler stores the license key in the license key memory or reads the license key from the license key memory.

35. The method as claimed in claim 25, wherein the first and second license key handlers are configured to handle license keys of different types, and the license key handler manager identifies a type of the identified at least first or the second license key handler.

36. The method as claimed in claim 25, further comprising adding software modules to the license key handler manager for updating the license key handler manager to communicate with a new type of license key handler.

37. The method as claimed in claim 25, wherein the license key handler manager is provided with the license key over the Internet.
